(19) United States
(12) Patent Application Publication
(10) Pub. No.: US 2013/0081333 A1
(43) Pub. Date: Apr. 4, 2013

(54) STRIKERS, MOVABLE PARTITION SYSTEMS INCLUDING SUCH STRIKERS, AND RELATED METHODS

(71) Applicant: Ivan W. Stewart, Herriman, UT (US)

(72) Inventor: Ivan W. Stewart, Herriman, UT (US)

(73) Assignee: WON-DOOR CORPORATION, Salt Lake City, UT (US)

(21) Appl. No.: 13/251,996

(22) Filed: Oct. 3, 2011

(51) Int. Cl. E05D 15/12; E06B 3/00

(52) U.S. Cl. 49/404; 49/506

(57) ABSTRACT

Movable partition systems comprise a movable partition comprising at least one sheet of hingedly interconnected panels connectable to a lead post at an end of the movable partition. A striker configured to be disposed in a recess having a width formed in a wall toward which the movable partition is extendable comprises two sidewalls and a rear wall directly connected to the sidewalls defining a cavity having another, smaller width configured to receive the lead post at least partially therein. Such a striker may also include two flanges, each flange connected one of the two sidewalls and extending away from the cavity for a length greater than a difference in distance between the width of the cavity at its widest point and the width of the recess.

### FIELD

Embodiments of the disclosure relate generally to strikers for movable partition systems, movable partition systems including such strikers, and related methods. Specifically, embodiments of the disclosure relate to strikers which may simplify installation procedures while enabling a lead post of a movable partition to be at least partially inserted into the striker.

### BACKGROUND

Movable partitions are utilized in numerous situations and environments for a variety of purposes. Such partitions may include for example, foldable or collapsible doors configured to close off an opening in order to enclose a room or to subdivide a single large room into one or more smaller rooms. The subdivision of one or more larger areas may be desired, for example, to accommodate the simultaneous meeting of multiple groups in different areas of a larger partitioned space. In some applications, movable partitions are useful for providing privacy and noise reduction. In some applications, movable partitions are useful for providing a barrier, such as, for example, a security barrier or a fire barrier.

Movable partition systems conventionally include a movable partition, which may comprise two sheets of hingedly interconnected panels extending at least substantially parallel to one another. As the movable partition is extended from an open position to a closed position, the individual panels may rotate relative to one another in an accordion-like or plicated manner. Movable partitions may also conventionally include a lead post to which the sheets of interconnected panels may be connected at an end thereof. As the movable partition is deployed, the lead post may move toward and align with a striker. The striker conventionally comprises an elongated member having sidewalls that define a cavity into which the lead post may be at least partially inserted. When the movable partition is fully extended, the lead post may be at least partially received into the striker, forming a barrier, for example, to fire and smoke.

To ensure that the lead post is receivable into the striker, the striker may be aligned with the lead post, conventionally accomplished by having a centerline of the striker aligned with a centerline of the lead post. Thus, installation of the striker conventionally has required forming a recess in a building surface, such as in a wall, in which the striker is disposed. Inaccurate or imprecise placement of the recess, however, may cause a striker disposed therein to be misaligned from the lead post. Such misalignment may require the recess to be moved or resized, which may involve requiring a contractor to return to the installation site and requiring the contractor to modify or redo the work of creating the recess. In addition, a contractor may conventionally return to the installation site after a striker is installed to seal around the edges of the striker, using a sealant such as caulk, and then paint the sealed edges to match the surroundings. Performing such modification and finishing labor may increase cost, delay installation, and disrupt other construction or installation performed at the site.

### BRIEF DESCRIPTION OF THE DRAWINGS

While the specification concludes with claims particularly pointing out and distinctly claiming what are regarded embodiments of the invention, various features and advantages of disclosed embodiments may be more readily ascertained from the following description of some example embodiments when read in conjunction with the accompanying drawings, in which:

FIG. 1 is a perspective view of a movable partition system;

FIG. 2 is a simplified plan view of the movable partition system of FIG. 1;

FIG. 3 is a perspective view of a portion of the door post comprising a striker of FIG. 2; and

FIG. 4 is an enlarged cross-sectional view of the a portion of the movable partition system as shown in FIG. 2.

### DETAILED DESCRIPTION

The illustrations presented herein are not meant to be actual views of any particular striker, movable partition system, or component thereof, but are merely idealized representations that are employed to describe example embodiments. Thus, the drawings are not necessarily to scale and relative dimensions may have been exaggerated or diminished for the sake of clarity. Additionally, elements common between figures may retain the same or similar numerical designation.

Embodiments of the disclosure relate to strikers including flanges which may simplify installation procedures while enabling lead posts of movable partitions to be at least partially inserted into the strikers. More specifically, disclosed embodiments relate to strikers that may be installed in recesses formed in walls, wherein the strikers include flanges which enable cavities defined by the strikers to be aligned with lead posts of movable partitions in fully extended states despite misalignment of centerlines of the recesses with the lead posts.

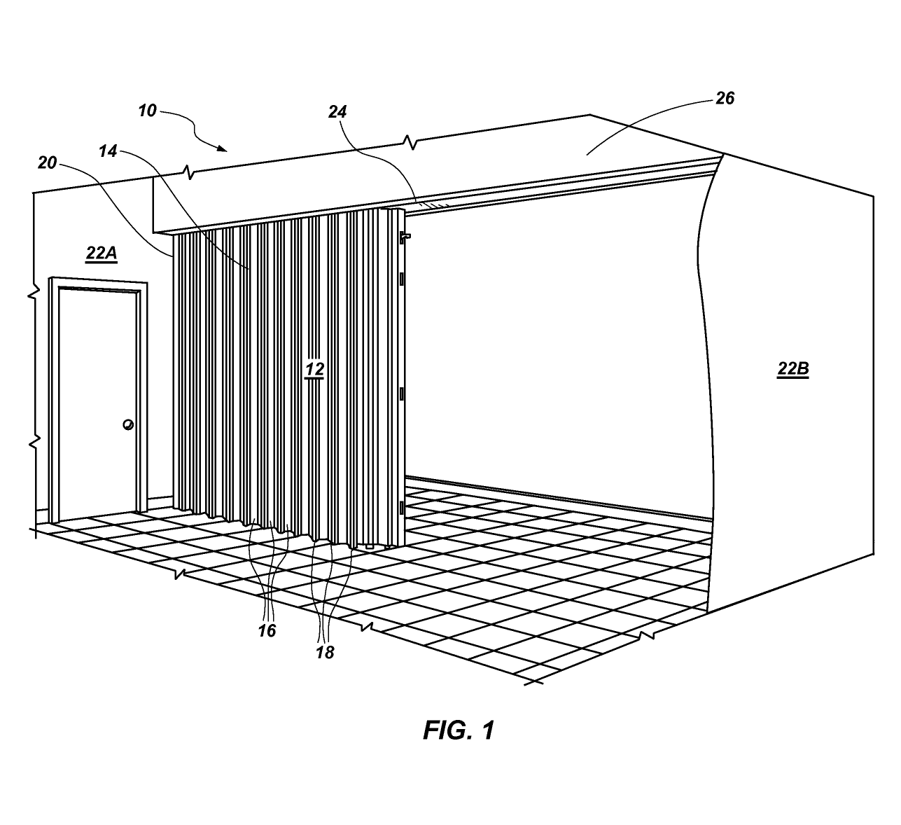

Referring to FIG. 1, a perspective view of a movable partition system 10 is shown. The movable partition system 10 may include a movable partition 12 that may be automatically extended, automatically retracted, or both automatically extended and automatically retracted. The movable partition 12 also may be manually extended, manually retracted, or both manually extended and manually retracted. In other words, the movable partition 12 may be moved both automatically and manually, as desirable. The movable partition 12 may be used for partitioning space, as a sound barrier, as a fire barrier, as a security barrier, for combinations of such purposes, or for other purposes.

The movable partition 12 may comprise, for example, an accordion-type folding door. The movable partition 12 may include two sheets of panels 14 extending at least substantially parallel to one another connected at their ends to define an interior space between the sheets of panels 14. Each sheet of panels 14 may include a plurality of panels 16 hingedly connected to one another, with hinges or other hinge-like members 18. The hinges or other hinge-like members 18 may comprise separate structures from the panels 16, or they may be integrally formed with the panels 16 and interconnected to form the sheet of panels 14. The hinged connection of the panels 16 enables the panels 16 to fold, and the movable partition 12 to collapse, in a plicated manner as the movable partition 12 is refracted, which enables the movable partition 12 to be stored compactly in a pocket 20 formed in a wall 22A of a building when in a retracted state. In other embodiments, the movable partition 12 may comprise a sliding door or another type of movable partition 12.

When the movable partition 12 is deployed to an extended position, the movable partition 12 may be driven along a track 24 across the space to provide an appropriate barrier. The track 24 may comprise an overhead track disposed in a header assembly 26. In such embodiments, the movable partition 12 may be suspended from and movable along the track 24.

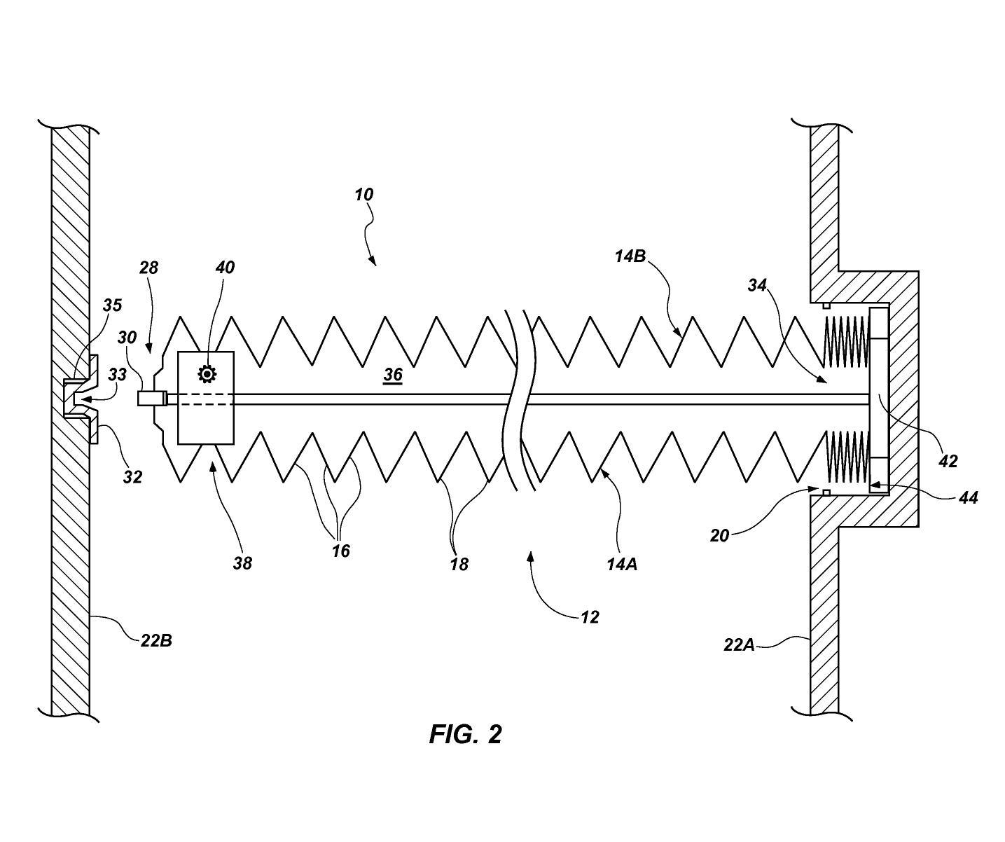

Referring to FIG. 2, a simplified plan view of the movable partition system 10 of FIG. 1 is shown. A first end 28 of the movable partition 12, which may comprise a leading end as the movable partition 12 extends, may include a lead post 30 disposed at the first end 28. The lead post 30 may be configured to matingly (i.e., complementarily) engage with a striker 32 that may be located in another wall 22B of a building when the movable partition 12 is deployed to a fully extended state. More specifically, the lead post 30 may be at least partially received into a cavity 33 defined by the striker 32 when the movable partition 12 is fully extended. The striker 32 may be disposed in a recess 35 formed in the other wall 22B. A second, opposing end 34 of the movable partition 12 may be located opposite the first end 28 and may be disposed in the pocket 20.

The movable partition system 10 may include a first sheet of panels 14A and a second sheet of panels 14B laterally spaced from and extending substantially parallel to the first sheet of panels 14A. The first ends 28 of the first and second sheets of panels 14A and 62B may be attached at or near the lead post 30. For example, the first and second sheets of panels 14A and 14B may be attached directly to the lead post 30, may be attached to one another and then to the lead post 30, or may be attached to an intermediate structure that is then attached to the lead post 30. Such a movable partition 12 may be used, for example, as a fire door, wherein one sheet of panels 14A acts as a primary fire and smoke barrier, an interior space 36 between the first sheet of panels 14A and the second sheet of panels 14B acts as an insulator or a buffer, and the second sheet of panels 14B acts as a secondary fire and smoke barrier. Such a configuration may also be useful in providing an acoustic barrier when the movable partition 12 is used to subdivide a larger space into multiple rooms.

In some embodiments, the movable partition system 10 may also include an automatic drive system 38. The automatic drive system 38 may be disposed in the interior space 36 between the first sheet of panels 14A and the second sheet of panels 14B in some embodiments. The automatic drive system 38 may be attached to and carried by the movable partition 12, and may move cooperatively therewith as the movable partition 12 is extended or retracted. In some embodiments, all of the drive components of the movable partition system 10 may be confined between the first sheet of panels 14A and the second sheet of panels 14B.

The automatic drive system 38 may be positioned near the lead post 30 of the movable partition system 10. The automatic drive system 38 may include a motor (not shown) carried by the movable partition 12 as described in detail in U.S. patent application Ser. No. 12/542,448 which was filed Aug. 17, 2009 and is entitled “Methods, Apparatuses, and Systems for Driving a Movable Partition,” in U.S. patent application Ser. No. 12/758,584, which was filed Apr. 12, 2010 and is entitled “Methods, Apparatuses, and Systems for Movable Partitions,” and in U.S. patent application Ser. No. 12/838,235, which was filed Jul. 16, 2010 and is entitled “Methods, Apparatuses, and Systems for Movable Partitions,” the disclosure of each of which is hereby incorporated herein in its entirety by this reference. Briefly, the automatic drive system 38 may be configured to automatically open, automatically close, or to both automatically open and automatically close the movable partition 12 upon actuation thereof. The automatic drive system 38 may include an elongated drive member (not shown), which may comprise, for example, a chain, belt, cable, or rope having fixed ends. A rotatable drive member 40, such as, for example, a pulley, wheel, cog, or sprocket, may be configured to engage the elongated drive member such that when the rotatable drive member 40 is rotated, the rotatable drive member 40 moves along the elongated drive member causing the movable partition 12 to automatically extend to a deployed state or automatically retract to a collapsed state.

In other embodiments, the automatic drive system 38 may comprise a motor or other actuator for extending a movable partition fixedly located in the pocket 20. For example, a drive system as disclosed in U.S. Pat. No. 7,782,019 issued Aug. 24, 2010 to Banta et al., the disclosure of which is incorporated herein in its entirety by this reference, may be used.

The movable partition system 10 may also include a control system 42. For example, the control system 42 may comprise a control system as disclosed in U.S. Pat. No. 6,662,848, issued Dec. 16, 2003 to Goodman et al., the disclosure of which is incorporated herein in its entirety by this reference. The control system 42 may be operatively coupled to the automatic drive system 38 and may control, for example, actuation of the automatic drive system 38 to extend and retract the movable partition 12. The control system 42 may be located at or near the second, opposing end 34 of the movable partition 12. For example, the control system 42 may be located in the pocket 20. The second, opposing ends 34 of the first and second sheets of panels 14A and 14B may be connected to a floating jamb 44, which may also be located within the pocket 20, in some embodiments. In other embodiments, the second opposing ends 34 of the first and second sheets of panels 14A and 14B may be connected to a fixed jamb (not shown), which may be located within the pocket 20 or secured to the wall 22A surface. The control system 42 may be located on a side of the floating jamb 44 opposing the movable partition 12. The control system 42 may comprise, for example, a processor, a power supply, input and output ports, power ports, a battery system, switches, and other components known in the art for controlling the operation of a movable partition system 10.

As the movable partition 12 is deployed to a fully extended position, the lead post 30 of the movable partition 12 may be received at least partially into the cavity 33 defined by the striker 32. Thus, the lead post 30 may align with the cavity 33 and be inserted at least partially therein when the movable partition 12 is fully extended. In embodiments where the movable partition 12 is used as a barrier to fire, engagement of the lead post 30 with the striker 32 may create a barrier to smoke and flames. Accordingly, misalignment of the striker 32 with respect to the lead post 30 may cause the lead post 30 not to engage properly with the striker 32, which may leave gaps through which smoke, flames, or smoke and flames may pass. In extreme cases of misalignment, the lead post 30 may contact surfaces of the striker 32 or the wall 22B, which may prevent the lead post 30 from being inserted into the cavity 33 as intended. Accordingly, installation of the striker 32 has conventionally required that the recess 35 in which the striker 32 is disposed be located accurately and precisely to ensure proper engagement of the lead post 30 with the striker 32. For example, forming the recess 35 in the other wall 22B at a location that is greater than 0.25 in (0.64 cm) out of alignment has conventionally required that the contractor return to the installation site and modify the recess 35 or even completely reconstruct the recess 35.

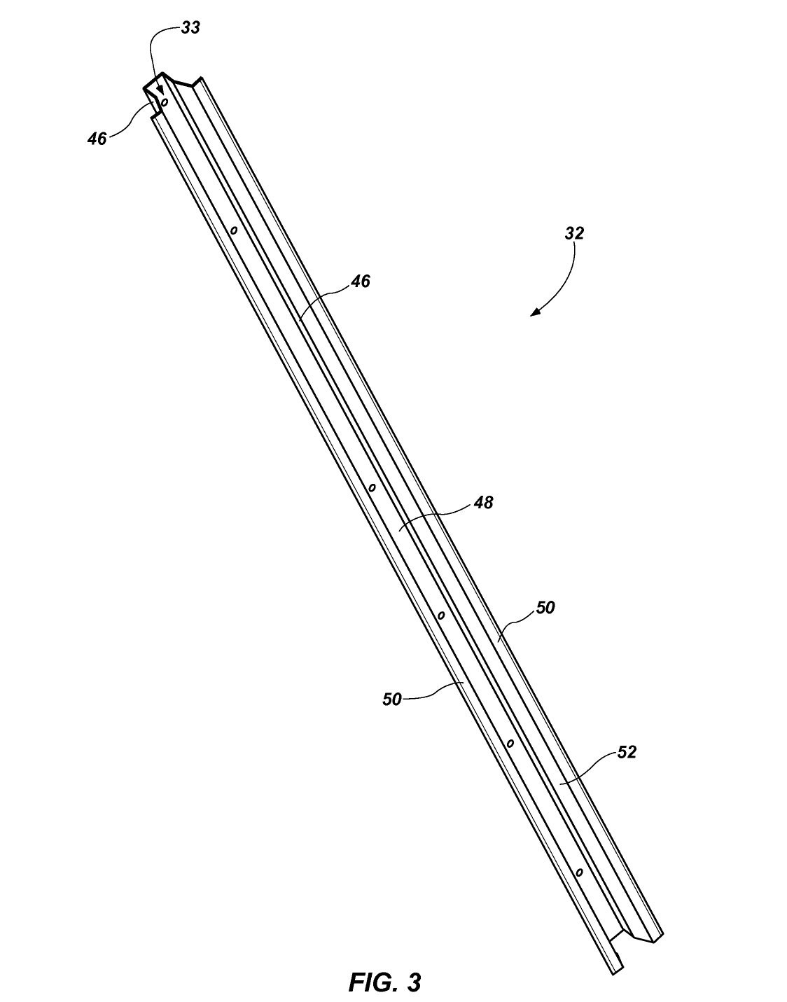

Referring to FIG. 3, a perspective view of a portion of the striker 32 of FIG. 2 is shown. The striker 32 may comprise at least two sidewalls 46 defining the cavity 33 configured to receive the lead post 30 (see FIG. 2) of the movable partition 12 (see FIG. 2) at least partially therein. The sidewalls 46 may extend at least substantially parallel to one another, and may extend in a direction that is at least substantially parallel to a direction in which the movable partition 12 (see FIG. 2) extends when being deployed. The sidewalls 46 may extend outwardly from a rear wall 48 further defining the cavity 33. The rear wall 48 may extend in a direction at least substantially transverse to the direction in which the sidewalls 46 extend. The striker 32 may further include at least one flange 50 connected to at least one of the sidewalls 46. For example, a flange 50 may be connected to each sidewall 46. The flanges 50 may extend outwardly away from the cavity 33. For example, the flanges 50 may extend in a direction at least substantially transverse to the direction in which the sidewalls 46 extend. Guide walls 52 may be directly connected to and interposed between the sidewalls 46 and the flanges 50 in some embodiments. The guide walls 52 may extend in a direction oblique to the direction in which the sidewalls 46 extend and to the direction in which the flanges 50 extend. In other embodiments, the flanges 32 may be directly connected to and extend directly from the sidewalls 46.

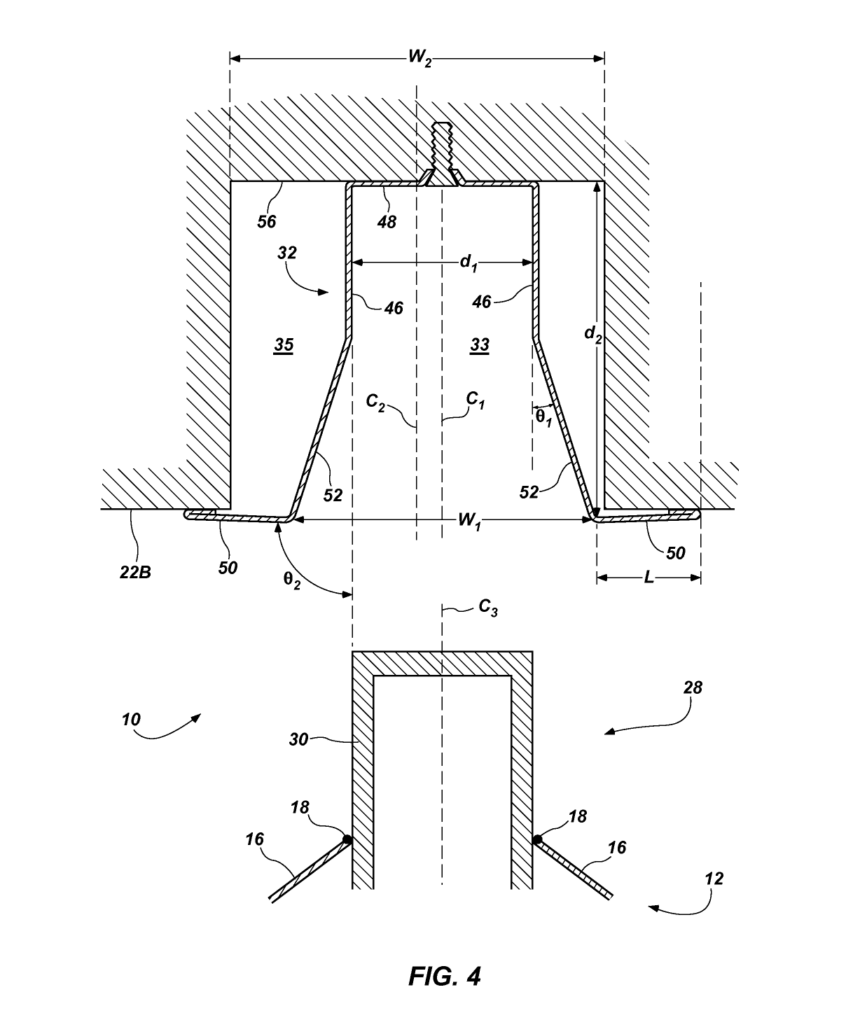

Referring to FIG. 4, an enlarged partial cross-sectional view of a portion of the movable partition system 10 of FIG. 2 is shown. Specifically shown are the striker 32, the wall 22B including the recess 35 in which the striker 32 is disposed, and the leading first end 28 of the movable partition 12. Referring to the striker 32, a distance d₁ between the sidewalls 46, and therefore the distance d₁ over which the rear wall 48 extends, may be sufficiently large to enable the lead post 30 to be at least partially received into the cavity 33 defined by the sidewalls 46. Sides of the lead post 30 may abut against both of the sidewalls 46 when the lead post 30 is at least partially inserted into the striker 32 in some embodiments. In such embodiments, surface contact between surfaces of the lead post 30 and the surfaces defining the cavity 33 (i.e., the sidewalls 46 and the rear wall 48) may provide a barrier to smoke, fire, light, sound, etc. In other embodiments, at least one gap may be present between at least one surface of the lead post 30 and at least another surface defining the cavity 33 (e.g., one of the sidewalls 46 or the rear wall 48). For example, the distance d₁ between the sidewalls 46 may be between about 2.25 in (5.72 cm) and 3.85 in (9.78 cm). More specifically, the distance d₁ between the sidewalls 46 may be between about 2.10 in (5.33 cm) and about 2.4 in (6.10 cm) or between about 3.7 in (9.40 cm) and 4.0 in (10.16 cm).

A distance d₂ between frontmost surfaces of the flanges 50 and the rear wall 48 may be sufficiently large to enable the rear wall 48 to be secured to a rear surface 56 at least partially defining the recess 35 in which the striker 32 may be disposed while the flanges 50 remain outside the recess 35. For example, the distance d₂ between the frontmost surfaces of the flanges 50 and the rear wall 48 may be sufficiently large to enable the rear wall 48 to be attached to a framing stud or other building structure within the recess 35 while the flanges 50 may be located outside the recess 35 and may extend along (e.g., make contact with) the other wall 22B in which the recess 35 is formed. For example, the distance d₂ may be about 4.25 in (10.80 cm). More specifically, the distance d₂ between the front surfaces of the flanges 50 and the rear wall 48 may be between about 4.10 in (10.41 cm) and about 4.4 in (11.18 cm).

A width W₁ of the cavity 33 at its widest point may be less than a width W₂ of the recess 35 at an end of the recess 35 opposing the rear surface 56. The flanges 50 may have a length L sufficiently large to conceal the recess 35 behind the flanges 50 as the flanges 50 extend over the surface of the other wall 22B, which may enable the striker 32 to be disposed in unmodified recesses 35 that are misaligned with lead posts 30 to a greater extent than was previously tolerable using conventional strikers. Thus, the flanges 50 may enable faster and easier installation of the striker 32 because the striker 32 may still be installed in an unmodified recess 35 originally formed in a location that is not precisely and accurately aligned with the lead post 30. Accordingly, the striker 32 may be installed in the recess 35 such that a centerline C₁ (e.g., a plane of symmetry) of the striker 32 is offset from a centerline C₂ (e.g., a plane of symmetry) of the recess 35 to properly align the recess 33 with the lead post 30, despite the recess 35 being out of alignment with the lead post 30. In other words, the centerline C₁ of the striker 32 may be aligned with a centerline C₃ (e.g., a plane of symmetry) of the lead post 30, while the centerline C₂ of the recess 35 is offset from the centerline C₁ of the striker 32 and the centerline C₃ of the lead post 30.

The flanges 50 may extend for a length L in a direction at least substantially transverse (e.g., perpendicular) to a direction of intended travel of the movable partition 12. In some embodiments, the flanges 50 may extend in a direction at least substantially transverse to a direction in which the sidewalls 46 extend. To enable the flanges 50 to conceal the recess 35 behind the flanges 50, the length L of each flange 50 may be greater than a difference in distance between the width W₁ of the cavity 33 at its widest point and the width W₂ of the recess 35 at the end opposing the rear surface 56. With regard to the difference in distance between the width W₁ of the cavity 33 at its widest point and the width W₂ of the recess, the width W₁ of the cavity 33 at its widest point may be, for example, between about 80% as wide as the width W₂ of the recess 35 and about 99% as wide as the width W₂ of the recess 35. More specifically, the width W₁ of the cavity 33 at its widest point may be between about 90% as wide as the width W₂ of the recess 35 and about 95% as wide as the width W₂ of the recess 35. As a specific, non-limiting example, the width W₁ of the cavity 22 at its widest point may be about 93% as wide as the width W₂ of the recess 35.

The length L of each flange 50 may be, for example, at least about 0.75 in (1.91 cm). More specifically, the length L of each flange 50 may be about 1.00 in (2.54 cm), about 1.25 in (3.18 cm), about 2.00 in (5.08 cm), about 3.00 in (7.62 cm), or even greater. Similarly, the difference in distance between the width W₁ of the cavity 33 at its widest point and the width W₂ of the recess 35 at the end of the recess 35 opposing the rear surface 56 may be at least about 0.75 in (1.91 cm). More specifically, the difference in distance between the width W₁ of the cavity 33 at its widest point and the width W₂ of the recess 35 at the end of the recess 35 opposing the rear surface 56 may be about 0.99 in (2.51 cm), about 1.24 in (3.15 cm), about 1.99 in (5.05 cm), about 2.99 in (7.59 cm), or even greater. Thus, the flanges 50 may conceal the recess 35 even where the striker 32 is offset to either maximum side position within the recess 35.

The length L for which each flange extends may be at least 20% as great as a greatest width of the cavity 33. Thus, the length L of each flange may be at least 20% as great as the width W₁ of the cavity 33 at an end of the cavity 33 opposing the rear wall 48 in embodiments where tapered guide walls 52 extend between the sidewalls 46 and the flanges 50. In embodiments where the sidewalls 46 define the greatest width of the cavity 33, the length L of each flange may be at least 20% as great as the distance d1 between the sidewalls 46. As specific, non-limiting example, the length L of each flange may be 25% as great as the width W₁ of the cavity 33 at its widest point, 30% as great as the width W₁ of the cavity 33 at its widest point, 35% as great as the width W₁ of the cavity 33 at its widest point, or even greater with respect to the width W₁ of the cavity 33 at its widest point.

In embodiments where guide walls 52 are directly connected to and extend between the sidewalls 46 and the flanges 50, the cavity 33 may increase in width in a direction extending from the rear wall 48 toward the flanges 50 due to the oblique included angle θ₁ from the sidewalls 46 at which the guide walls 52 extend. In other words, the width W₁ of the cavity 33 at the end opposing the rear wall 48 may be greater than the distance d₁ between the sidewalls 46 due to the oblique included angle θ₁ from the sidewalls 46 at which the guide walls 52 extend. For example, the oblique included angle θ₁ from the sidewalls 46 at which the guide walls 52 extend may be about 17.35°. More specifically, the oblique angle θ₁ from the sidewalls 46 at which the guide walls 52 extend may be between about 10° and about 25°. In other embodiments, the guide walls 52 may be stepped at varying oblique angles or may be curved. In still other embodiments, the sidewalls 46 may be directly connected to the flanges 50. The cavity 33 may be of at least substantially constant width in such embodiments. In other words, the width W₁ of the cavity 33 at its widest point may be equal to the distance d₁ between the sidewalls 46. In yet other embodiments, sidewalls 46 directly connected to the flanges 50 may extend at an angle to a direction in which the movable partition 12 extends such that the width W₁ of the cavity 33 at the end opposing the rear wall 48 is larger than the distance d₁ between the sidewalls 46 near the rear wall 48 and the distance d₁ between the sidewalls 46 gradually increases as distance away from the rear wall 48 increases. The width W₁ of the cavity 33 at its widest point may be large enough to enable the lead post 30 to be at least partially inserted into the cavity 33 and small enough to enable the striker 32 to be offset within the recess 35. For example, the width W₁ of the cavity 33 at its widest point may be between about 2.25 in (5.72 cm) and about 4.00 in (10.16 cm). More specifically, the width W₁ of the cavity 33 at its widest point may be about 3.84 in (9.75 cm).

In some embodiments, the flanges 50 may extend in a direction that is perpendicular to the direction in which the sidewalls 46 extend. In other embodiments, the flanges 50 may extend in a direction that is oblique to the direction in which the sidewalls 46 extend. For example, the flanges 50 may extend at an oblique angle θ₂ to the sidewalls 46 causing the flanges to extend at least somewhat toward the rear wall 48 as the flanges 50 also extend away from the centerline C or plane of symmetry of the striker 32. For example, the oblique angle θ₂ to the sidewalls 46 at which the flanges 50 may extend may be greater than 90°. More specifically, the oblique angle θ₂ to the sidewalls 46 at which the flanges 50 may extend may be between about 90.1° and about 95°. Thus, when it is said that the flanges 50 may extend in a direction at is at least substantially transverse to a direction in which the sidewalls 46 extend, it is meant that the flanges may extend in a direction that is perpendicular to the direction in which the sidewalls 46 extend or may extend in a direction oblique to the direction in which the sidewalls 46 extend. In embodiments where the flanges 50 extend in a direction that is oblique to the direction in which the sidewalls 46 extend, the outer extents of the flanges 50 may contact the other wall 22B before the rest of the flanges 50 as the striker 32 is inserted into the recess 35 in the other wall 22B. Upon further insertion into the recess 35, the flanges 50 may bend and comply until the flanges 50 are flush against the other wall 22B. In the event that the recess 35 is shallower than the distance d₂ between the rear wall 48 and the frontmost surfaces of the flanges 50, the oblique angle θ₂ at which the flanges 50 extend may still enable the flanges 50 to contact the other wall 22B, at least at the outermost extent of the flanges 50. Thus, the flanges 50 may enable the striker 32 to be used with recesses 35 that are both out of lateral alignment with the lead post 30 and are not precisely and accurately as deep as intended.

The striker 32 may be formed using conventional processes. For example, the striker 32 may be formed by bending, roll forming, welding, or otherwise manipulating sheets of material to form the various portions (e.g., the flanges 50, the guide walls 52, the sidewalls 46 and the rear wall 48) of the striker 32. The striker 32 may be formed from a single, unitary sheet of material in some embodiments. In other embodiments, the striker 32 may comprise at least two, and potentially more, separate sheets of material that have been joined to one another to form the striker 32. As a specific, nonlimiting example, the striker 32 may be formed from a single, unitary piece of sheet metal that has been roll formed to produce the various portions (e.g., the flanges 50, the guide walls 52, the sidewalls 46 and the rear wall 48) of the striker 32.

When installing the striker 32 as part of a movable partition system 10 (see FIG. 2), a recess 35 configured to receive the striker 32 partially therein may be formed in the other wall 22B opposite the wall 22A from which the movable partition 12 may extend. The centerline C₂ of the recess 35 may be aligned with the centerline C₃ of the lead post 30 disposed at the leading end 28 of the movable partition 12 in some embodiments. In other embodiments, the centerline C₂ of the recess 35 may be offset from the centerline C₃ of the lead post 30. The recess 35 may be, for example, between about 4.0 in (10.16 cm) wide and about 5.0 in (12.70 cm) wide and between about 4.00 in (10.16 cm) deep and about 4.5 in (11.43 cm) deep. More specifically, the recess may be about 4.125 in (10.48 cm) wide and about 4.25 in (10.80 cm) deep.

The striker 32 may be disposed in the recess 35. The centerline C₁ of the striker 32 may be aligned with the centerline C₃ the lead post 30, as shown in FIG. 4. Accordingly, the centerline C₁ the striker 32 may be aligned with the centerline C₂ the recess 35 in embodiments where the centerline C₂ the recess 35 is also aligned with the centerline C₃ the lead post 30. The centerline C₁ the striker 32 may be offset from the centerline C₂ the recess 35 in embodiments where the centerline C₂ the recess 35 is misaligned with the centerline C₃ the lead post 30, as shown in FIG. 4. The flanges 50 of the striker 32 may conceal the recess 35 behind the striker 32. Thus, as the striker 32 is disposed within the recess during installation, the flanges 50 of the striker 32 may extend laterally outward over the surface of the other wall 22B regardless of whether the striker 32 is centered within the recess 35 or offset within the recess 35. In this way, the flanges 50 may enable the striker 32 to be installed in an unmodified recess 35 that is in perfect alignment with the lead post 30 or is out of alignment with the lead post 30 by a distance up to a difference in distance between the width W₁ of the cavity at its widest point and the width W₂ of the recess 35. For example, the centerline C₂ of the recess 35 may be at least 0.5 in (1.27 cm) out of alignment with the lead post 30, at least 0.75 in (1.91 cm) out of alignment with the lead post 30, at least 0.88 in (2.24 cm) out of alignment with the lead post 30, or even greater than 1.0 in (2.54 cm) out of alignment with the centerline C₃ of the lead post 30.

Once the striker 32 is properly aligned with the lead post 30, the striker 32 may be secured within the recess 35. For example, the rear wall 48 of the striker 32 may abut against and be secured to a building structure (e.g., a framing stud) within the recess 35. More specifically, the rear wall 48 may include holes 54 formed through the rear wall 48, through which screws, bolts, or nails may be inserted. Thus, the striker 32 may be screwed, bolted, or nailed within the recess 35, though the striker 32 may be secured within the recess in other ways, such as, for example, using a snap-fit connection, using an adhesive, etc. The striker 32 may not require additional finishing work, such as, for example, sealing around edges of the striker 32 or painting exposed portions of the recess 35, because at least the distal ends of the flanges 50 may contact the other wall 22B and because the recess 35 may be completely concealed behind the striker 32. In this way, the striker 32 may enable an installer to complete installation of the striker in a faster, more efficient manner than previously possible with conventional strikers. In some embodiments, however, the edges of the striker 32 may be sealed to the wall 22B (e.g., using caulking) and painted or otherwise finished as desirable.

In operation, the lead post 30 of a movable partition 12 may extend toward the striker 32 as the movable partition 12 is deployed. The lead post 30 may come into contact with the striker 32. For example, as the lead post 30 approaches a fully extended position, the lead post 30 may come into contact with one of the guide walls 52. The angled or curved geometry of the guide walls 52 may cause a centerline or plane of symmetry of the lead post 30 to move toward, and eventually align with, the centerline C or plane of symmetry of the striker 32 as the lead post 30 advances into the recess 33 defined by the striker 32. When the movable partition 12 is fully extended, the lead post 30 may contact the rear wall 48 of the striker 32 in some embodiments. In such embodiments, the lead post 30 may also contact one or both of the sidewalls 46. In other embodiments, the lead post 30 may not contact the rear wall 48 of the striker 32 when the movable partition 12 is fully extended, but may contact one or both of the sidewalls 46. Contact between the lead post 30 and the striker 32 may provide a barrier, such as, for example, to smoke, flame, or sound.

While the present invention has been described herein with respect to certain embodiments, those of ordinary skill in the art will recognize and appreciate that it is not so limited. Rather, many additions, deletions, and modifications to the embodiments described herein may be made without departing from the scope of the invention as hereinafter claimed, including legal equivalents. In addition, features from one embodiment may be combined with features of another embodiment while still being encompassed within the scope of the invention as contemplated by the inventor.

### CONCLUSION

In some embodiments, strikers for use with a movable partition system comprise two sidewalls defining a cavity configured to receive a lead post of a movable partition at least partially therein. Such strikers may also include two flanges, each flange connected to one of the two sidewalls and extending outwardly away from the cavity for a length that is at least 20% of a width of the cavity at its widest point.

In other embodiments, movable partition systems comprise a movable partition comprising at least one sheet of hingedly interconnected panels connectable to a lead post at an end of the movable partition. A striker configured to be disposed in a recess having a width formed in a wall toward which the movable partition is extendable comprises two sidewalls and a rear wall directly connected to the sidewalls defining a cavity having another, smaller width configured to receive the lead post at least partially therein. Such a striker may also include two flanges, each flange connected one of the two sidewalls and extending away from the cavity for a length greater than a difference in distance between the width of the cavity at its widest point and the width of the recess.

In further embodiments, methods of installing a movable partition system comprise suspending a movable partition comprising at least one sheet of hingedly interconnected panels connected to a lead post at an end of the movable partition from a track. A recess having a width is formed in a wall toward which the movable partition is extendable. A cavity of a striker defined by at least two sidewalls and a rear wall of the striker, the cavity having another width at its widest point less than the width of the recess and configured to receive the lead post at least partially therein, is aligned with the lead post. The striker is secured within the recess. The recess is concealed and at least a portion of the wall on each side of the recess is covered behind a flange of two flanges of the striker connected to the two sidewalls and extending away from the cavity.

What is claimed is:

1. A striker for use with a movable partition system, comprising:
two sidewalls defining a cavity configured to receive a lead post of a movable partition at least partially therein; and
two flanges, each flange connected to one of the two sidewalls and extending outwardly away from the cavity for a length that is at least 20% of a width of the cavity at its widest point.

2. The striker of claim 1, wherein the flanges extend in a direction at least substantially transverse to a direction in which the sidewalls extend.

3. The striker of claim 2, wherein an included angle between each sidewall and its corresponding flange is greater than 90°.

4. The striker of claim 1, wherein the flanges extend outwardly away from the cavity for a length greater than a difference in distance between a width of the cavity at its widest point and a width of a recess in which the striker is configured to be disposed.

5. The striker of claim 1, wherein two guide walls are directly connected to and extend at oblique angles with respect to the two sidewalls and the two flanges and further define the cavity.

6. The striker of claim 1, wherein each flange extends outwardly away from the cavity for a length of at least about 0.75 in (1.91 cm).

7. The striker of claim 1, wherein the two sidewalls and the two flanges are portions of a single, integrally formed unit.

8. A movable partition system, comprising:
a movable partition comprising at least one sheet of hingedly interconnected panels connectable to a lead post at an end of the movable partition; and
a striker configured to be disposed in a recess having a width formed in a wall toward which the movable partition is extendable, the striker comprising:
two sidewalls and a rear wall directly connected to the sidewalls defining a cavity having another, smaller width configured to receive the lead post at least partially therein; and
two flanges, each flange connected one of the two sidewalls and extending away from the cavity for a length greater than a difference in distance between the width of the cavity at its widest point and the width of the recess.

9. The movable partition system of claim 8, wherein the flanges extend in a direction at least substantially transverse to a direction in which the sidewalls extend.

10. The movable partition system of claim 8, wherein two guide walls extending at an oblique angle with respect to the two sidewalls and the two flanges are directly connected to and extend between the two sidewalls and the two flanges and further define the cavity.

11. The movable partition system of claim 8, wherein each flange extends from one of the two sidewalls away from the cavity for a length of at least about 1.25 in (3.18 cm).

12. The movable partition system of claim 8, wherein the difference in distance between the width of the cavity proximate the flanges and the width of the recess is at least 0.75 inch (1.91 cm).

13. The movable partition system of claim 8, wherein the two flanges contact the wall on each side of the recess.

14. The movable partition system of claim 13, wherein the two flanges are flush with the wall on each side of the recess.

15. A method of installing a movable partition system, comprising:
suspending a movable partition comprising at least one sheet of hingedly interconnected panels connected to a lead post at an end of the movable partition from a track;
forming a recess having a width in a wall toward which the movable partition is extendable;
aligning a cavity of a striker defined by at least two sidewalls and a rear wall of the striker, the cavity having another width at its widest point less than the width of the recess and configured to receive the lead post at least partially therein, with the lead post;
securing the striker within the recess; and
concealing the recess and covering at least a portion of the wall on each side of the recess behind a flange of two flanges of the striker connected to the two sidewalls and extending away from the cavity.

16. The method of claim 15, wherein aligning the cavity of the striker with the lead post comprises aligning a centerline of the striker with a centerline of the lead post when the movable partition is in a fully extended state.

17. The method of claim 15, wherein securing the striker within the recess comprises offsetting a centerline of the striker from a centerline of the recess.

18. The method of claim 15, wherein forming the recess comprises forming the recess to have a width at least 0.75 inch greater than a width of the cavity at its widest point.

19. The method of claim 15, wherein concealing the recess and covering the at least a portion of the wall on each side of the recess behind a flange of the two flanges comprises contacting a surface of the wall on each side of the recess with a flange of the two flanges.

20. The method of claim 19, wherein contacting the surface of the wall on each side of the recess with a flange of the two flanges comprises abutting a surface of each flange flush against the surface of the wall on each side of the recess.
